(19) United States
(12) Patent Application Publication
(10) Pub. No.: US 2006/0120101 A1
(43) Pub. Date: Jun. 8, 2006

(54) Back light source for liquid crystal display

(76) Inventor: Juen Tien Peng, Chung Li (TW)

Correspondence Address: HDSL, 4331 STEVENS BATTLE LANE, FAIRFAX, VA, 22033, US

(21) Appl. No.: 11/000,954

(22) Filed: Dec. 2, 2004

(51) Int. Cl. F21V 7/04

(52) U.S. Cl. 362/561; 362/560

(57) ABSTRACT

A back light source for liquid crystal display (LCD) includes a support, a light-reflecting member, a lamp, and a diffusion plate. The support is made of plastic material having an opening on the top. The bottom surface of the support is a curved surface. The light-reflecting member is attached to the bottom surface. The lamp is received inside the support and positioned on the light-reflecting member. The diffusion plate is made of polymethyl methacrylate (PMMA) having good optical clarity. The present invention provides a back light source for LCD, which reduces the product cost and simples the structure of the back light source, thereby assembling easier.

### BACKGROUND OF THE INVENTION

1. Field of the Invention

The present invention relates to a light source device, and more particularly, to a back light source for liquid crystal display (LCD).

2. Description of the Prior Art

The conventional back light source for LCD typically comprises a housing, a support disposed inside the housing, a lamp received inside the support, a guide light plate covered on the increased light plate, and a diffusion plate positioned on the guide light plate. The conventional diffusion plate is made of polyethylene terephthalate (PET), and the guide light plate and the increased light plate are needed to ensure the optics performance of the light source. However, the guide light and the increased light plate cost a lot. The back light source has many members, thereby causing the assemble process more complicated.

In the view of this, the present invention provides a back light source for LCD in order to overcome the above-mentioned disadvantages.

### SUMMARY OF THE INVENTION

The present invention provides a back light source for LCD with a simplified structure, which is easy to assemble and costs less.

According to a preferred embodiment of the present invention, a back light source for LCD is provided, comprising a support, a light-reflecting member, a lamp, and a diffusion plate. The support is made of plastic material having an opening on the top. The light-reflecting member is attached to the bottom surface. The diffusion plate is covered on the lamp. The diffusion plate is made of polymethyl methacrylate (PMMA) having good optical clarity. The back light source for LCD of the present invention omits the guide light plate and the increase light plate, thereby reducing the product cost and simplifying the structure of the back light source to assemble easier.

The objectives of the present invention will become obvious to those of ordinary skill in the art after reading the following detailed description of the preferred embodiment.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view of a preferred embodiment of a back light source for LCD according to the present invention;

FIG. 2 is a top view of the preferred embodiment of a back light source for LCD having a lamp assembled on the support according to the present invention;

FIG. 3 is a schematic cross-sectional diagram along line A-A of FIG. 2;

FIG. 4 is a top view of the preferred embodiment of a back light source for LCD after assembled; and

FIG. 5 is a schematic cross-sectional diagram along line B-B of FIG. 4.

### DETAILED DESCRIPTION OF THE PREFERRED EMBODIMENTS

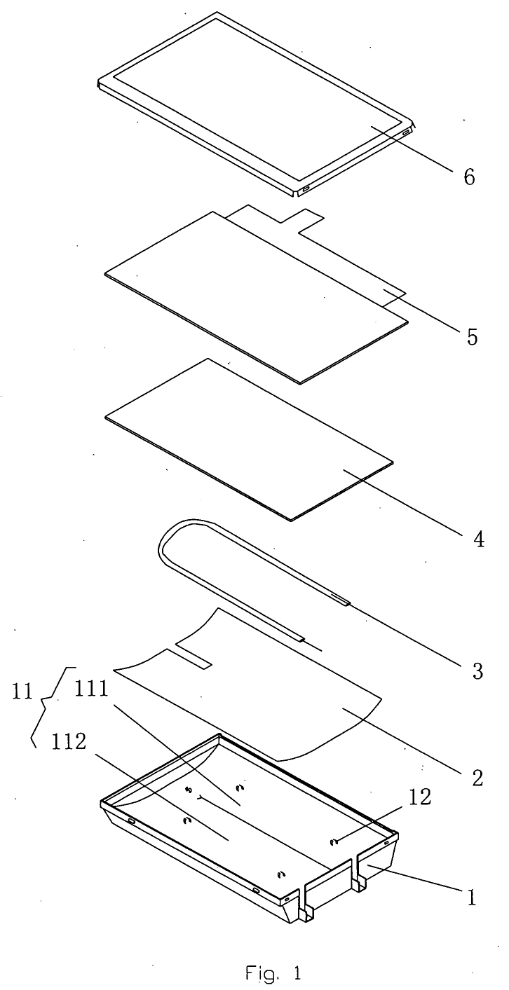

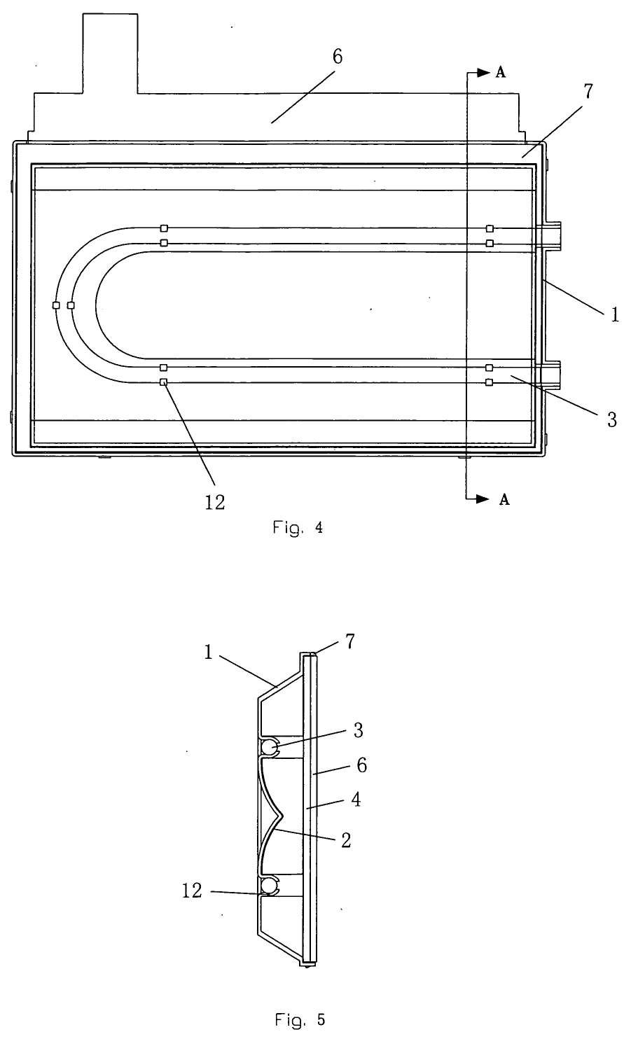

As shown in FIGS. 1 through FIG. 5, the present invention provides a back light source for LCD, which comprises a support 1, a light-reflecting member 2, a lamp 3, and a diffusion plate 4.

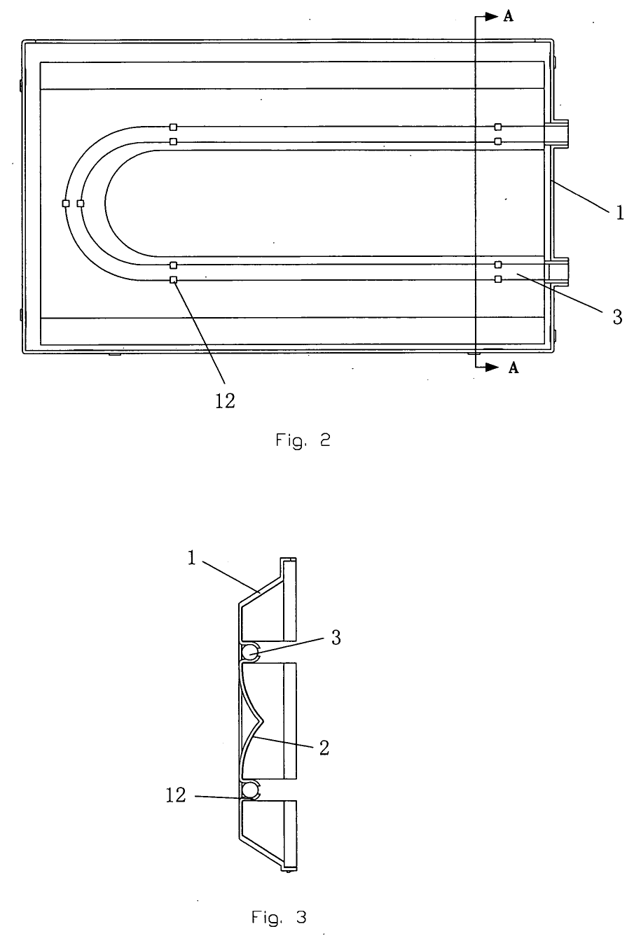

The support 1 is made of plastic material having an opening on the top. The bottom surface 11 of the support 1 is a curved surface. The curved surface 11 comprises two cambered surfaces 111 and 112 adjacent to each other, thereby projecting upwardly from the central section of the bottom surface 11, as shown in FIG. 2. A plurality of hooked members are disposed on the bottom surface 11 correspondingly fastened with the lamp 3.

The light-reflecting member 2 is attached to the bottom surface 11 of the support 1 for reflecting the light back from the lamp 3 in order to increase the light intensity.

The lamp 3 is received inside the support 1 and positioned on the light-reflecting member 2. The lamp 3 is formed of U-shape. Two sides of the lamp 1 are respectively received in two cambered surfaces 111 and 112 on the bottom surface 11, thereby reflecting the light by the cambered surfaces to make the reflected light more uniformly. The lamp 3 further comprises two fluorescent tubes received in two cambered surfaces 111 and 112, respectively to obtain the same effect.

The diffusion plate 4 is covered over the lamp 3. The diffusion plate 4 is made of polymethyl methacrylate (PMMA) having good optical clarity. A light-transmitting ink layer is coated on the diffusion plate 3 corresponding to the lamp 3 by the silk printing. The top surface on the diffusion plate 4 is formed with flocking, for examples, a plurality of etched patterns in order to increase the astigmatistic effect of the diffusion plate 4.

The back light source for LCD further comprises a layer of shielding member (not shown in the drawing), a panel 6 and a frame 7. The shielding member prevents the back light source for LCD from the external light. The panel 6 is disposed on the light-transmitting member in the opening on the top of the support 1, thereby sealing each member inside the support 1. The frame 7 is a hollow stand, and is made of steel material. The frame 7 is correspondingly hooked with the top portion of the support 1 to fasten, thereby forming a unity.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A back light source for liquid crystal display (LCD), comprising
a support having an opening and a bottom surface, the support made of plastic material, the bottom surface being a curved surface;
a light-reflecting member attached to the bottom surface;
a lamp received inside the support on the light-reflecting member; and
a diffusion plate covered over the lamp and made of polymethyl methacrylate (PMMA).

2. The back light source for LCD of claim 1, wherein a layer of shielding member is attached on the outer surface of the support.

3. The back light source for LCD of claim 1, wherein the bottom surface comprises two adjacent cambered surfaces, the lamp is U-shaped lamp, and two sides of the lamp are respectively received in two adjacent cambered surfaces.

4. The back light source for LCD of claim 1, wherein a light-transmitting ink layer is coated on the diffusion plate corresponding to the lamp by a silk printing, and etched patterns are disposed on the top of the diffusion plate.

5. The back light source for LCD of claim 4, wherein the color of light-transmitting ink layer is white.

6. The back light source for LCD of claim 1, wherein the back light source for LCD further comprises a panel and a frame, and wherein the panel is disposed in the opening of the support, and wherein the frame is hooked with the top of the support.

7. The back light source for LCD of claim 1, wherein a plurality of hooked members are disposed on the bottom surface for fastening with the lamp.
